(19) United States
(12) Patent Application Publication
(10) Pub. No.: US 2016/0114558 A1
(43) Pub. Date: Apr. 28, 2016

(54) CFKC Multiple Protection Composite

(71) Applicant: Eston Livingston, Whitewater, MO (US)

(72) Inventor: Eston Livingston, Whitewater, MO (US)

(21) Appl. No.: 14/851,820

(22) Filed: Sep. 11, 2015

Related U.S. Application Data
(60) Provisional application No. 62/050,545, filed on Sep. 15, 2014.

(51) Int. Cl. B32B 5/26; B32B 3/04

(52) U.S. Cl. CPC B32B 5/26; B32B 3/04; B32B 2255/02; B32B 2260/023; B32B 2307/3065; B32B 2571/02

(57) ABSTRACT

The claimed invention differs from what currently exists as Kevlar core is encased by resinated Jute A.K.A. burlap which is made from other natural fibers such as flax or hemp, with addition of one or more layers of resinated Kevlar, and/or Carbon Fiber Cloth and/or Aramid Cloth for additional structural support. Insulating intumescing is applied. This results in a Composite which becomes very strong with a reduction in raw material costs, that is not only resistant to projectiles, but is also resistant to acid and direct flame in excess of 2,000 degrees F. With the reduction in weight and low raw material costs of Jute/burlap, the ballistic resistant material can be used on a larger area for better protection.

### CROSS REFERENCE RELATED TO APPLICATION

Cross Reference to Provisional Application Filed—Sep. 15, 2014

Application No. 62/050,545

Ally Docket Number—510885984

Name of Applicant—Eston Livingston, Whitewater, Mo.

Title of Provisional Filed—Steel Replacement Composite—Resin, Fiber, and Insulating Intumescing with Ballistic Resistant Capabilities. A.K.A. as CFKC

### STATEMENT REGARDING FEDERALLY SPONSORED RESEARCH OR DEVELOPMENT

Not Applicable/None

### REFERENCE TO SEQUENCE LISTING, A TABLE, OR A COMPUTER PROGRAM LISTING COMPACT DISC

Not Applicable/None

### BACKGROUND OF THE INVENTION

Natural Resource Steel and/or concrete which is used in the manufacture of high impact ballistic resistant items are heavy and expensive. When used on transport vehicles or building/protection components they cause increased gas mileage and excessive weight. When used or carried by a person the added weight causes, lost agility and minimal coverage protection. The use of Composites as an alternative, in general, are not resistant to high heat and direct flame in excess of 2,000 degree F., and various acids, such as, but not limited to, Battery Acid.

### BRIEF SUMMARY OF THE INVENTION

The present invention is a cost effective moldable sheeting. Different grades are available to withstand various ballistic impact, high heat, direct flame and various acids. This invention has the potential of significant weight reduction compared to other ballistic resistant articles. This allows use on larger areas for better protection and/or the reduction of total weight with increased protection. CFKC, may also be used as an alternative to steel and/or aluminum parts and/or accessories with non ballistic resistant performance.

An embodiment of the invention its method to be molded into various shapes and sizes for a lower cost and weight reducing alternative for new and replacement parts.

Another aspect of the invention is the use of Jute in the fabrication process to further reduce raw material costs without reducing ballistic resistant performance intended for the composite.

It is therefore another aspect of the invention to provide protection against high heat and direct flame of 2,000 degree F. or more.

It is another aspect of the invention to provide protection against acid corrosion, such as but not limited to direct submersion in the battery acid for a period of 7 days or more.

### DESCRIPTION OF THE DRAWING

FIG. 1A-1D is a detailed drawing of the invention which visually depicts the composite.

FIG. 1A—Depicts one or more layers of woven Jute, the glossy fiber of either of two East Indian plants (Corchorus olitorius and C. capsularis) of the linden family (Tiliaceae), or burlap which is made from other natural fibers such as flax or hemp, that is fused to the next layer by resin with or without Pigment. Within the layers of Jute/Burlap one or more layers of Kevlar/Aramid Fiber or Carbon Fiber Cloth are added for additional structural support.

FIG. 1B—Depicts one or more layers of Ballistic Resistant core comprised of multiple layers of ballistic resistant material, preferably Kevlar or other materials which are well known for synthetic and natural ballistic resistant materials. Such as ceramics, PBO fiber, para-aramid synthetic fiber, polyethylene fiber and fiberglass.

FIG. 1C—Depicts one or more layers of woven Jute, the glossy fiber of either of two East Indian plants (Corchorus olitorius and C. capsularis) of the linden family (Tiliaceae), or burlap which is made from other natural fibers such as flax or hemp, that is fused to the next layer by resin with or without Pigment. Within the layers of Jute/Burlap one or more layers of Kevlar/Aramid Fiber or Carbon Fiber Cloth may be added for additional structural support.

FIG. 1D—Depicts Non Flammable Coating preferably Insulating Intumescing or other class A non flammable coating, which surrounds composite and/or is infused throughout the layers of composite.

### DETAILED DESCRIPTION OF THE INVENTION

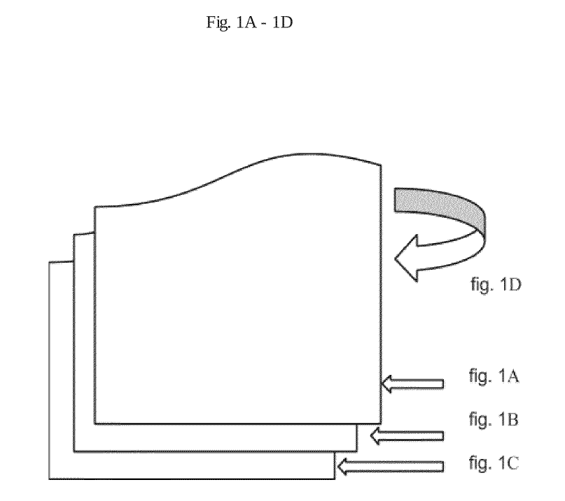

Shown in FIG. 1A-1D is an invention which can be molded or made into various sizes, shapes and grades for use in ballistic resistant systems for the multiple protection of human life and equipment from various projectiles, high heat, direct flame and provided cost reducing life cycle reduction due to the ability to withstands various direct contact acids. 1. This invention has one or more layers of woven Jute, the glossy fiber of either of two East Indian plants (Corchorus olitorius and C. capsularis) of the linden family (Tiliaceae), or burlap which is made from other natural fibers such as flax or hemp, which are stacked/layered. Kevlar Cloth, Carbon Fiber Cloth and other Aramid Clothes may also be substituted to the one or more layers of Jute/burlap for added structural strength. The number of layers of Jute and Kevlar Cloth can vary and depends on the strength/grade desired. 2. The above mentioned layers are wrapped around multiple layers of ballistic resistant fabric preferably Kevlar (known as the core). This core is constructed by securely attaching multiple layers of ballistic resistant fabric, preferably Kevlar together to form the basic core structure. 3. This Core is wrapped and secured within the multiple layers of step 1 above. This makes the basic shape of the invention which can then be pressure molded for various parts. 4. Resin saturation process begins 5. Insulating intumescing is applied.

1. A composite which is comprised of:
an outer surrounding casing that consists of multiple layers of resin with or without pigment, with multiple layers of Jute or burlap which is made of other natural fibers such as flax or hemp, with one or more layers of insulating intumescing or other class A fire protection coating.
an inner core which is encased within the outer surrounding casing that is comprised of multiple layers of ballistic resistant material, preferably Kevlar or other materials which are well known for synthetic and natural ballistic resistant materials. Such as ceramics, PBO fiber, para-aramid synthetic fiber, polyethylene fiber and fiberglass.

2. A composite which is comprised of claim 1 wherein said outer surrounding casing is made with added layer or layers of one or more of the following: Kevlar, Aramid or Carbon Fiber.

3. A composite which is comprised of claim 1 wherein said inner core is saturated with class A fire protection.

4. A composite which is comprised of claim 2 wherein said inner core is saturated with class A fire protection.
